(19) United States
(12) Patent Application Publication
(10) Pub. No.: US 2003/0182540 A1
(43) Pub. Date: Sep. 25, 2003

(54) Method for limiting physical resource usage in a virtual tag allocation environment of a microprocessor

(75) Inventors: William Elton Burky, Austin, TX (US); Dung Quoc Nguyen, Austin, TX (US); Balaram Sinharoy, Poughkeepsie, NY (US); Albert Thomas Williams, Austin, TX (US)

Correspondence Address: Jack V. Musgrove, 2911 Briona Wood Lane, Cedar Park, TX, 78613, US

(73) Assignee: INTERNATIONAL BUSINESS MACHINES CORPORATION, ARMONK, NY

(21) Appl. No.: 10/355,531

(22) Filed: Jan. 30, 2003

Related U.S. Application Data
(63) Continuation-in-part of application No. 10/104,728, filed on Mar. 21, 2002.

(51) Int. Cl. G06F 9/00

(52) U.S. Cl. 712/225; 712/218

(57) ABSTRACT

A method of handling instructions in a load/store unit of a processor by dispatching instructions to the load/store unit, filling a portion of physical entries of a reorder queue with tags corresponding to the instructions while limiting usage of the physical entries of the reorder queue to less than a total number of physical entries, and further dispatching one or more additional instructions to the load/store unit while the filled physical entries in the reorder queue are still full, i.e., still contain tags for uncompleted instructions. The limiting of usage of the physical entries may be selectively applied. Multiple logical instruction tags are assigned in a count greater than the number of physical entries in the reorder queue. Of the multiple logical instruction tags assigned to a single one of the physical entries in the reorder queue, only the tag for the oldest instruction is allowed to execute. A plurality of virtual/multiplier bits (V_{T}) are provided to tag allocations for the load/store unit, and the limiting of usage of the physical entries may be achieved by setting one or more of the virtual bits to prevent usage of a corresponding physical entry. A given V_{T} bit is flipped when a corresponding tag allocation wraps. The most significant bit of a given logical instruction tag is compared with the V_{T} bit to determine whether the given logical instruction tag is valid, i.e., is actually stored in a physical entry of the reorder queue.

### CROSS-REFERENCE TO RELATED APPLICATION

This application is a continuation-in-part of copending U.S. patent application Ser. No. 10/104,728 entitled “MECHANISM TO ASSIGN MORE LOGICAL LOAD/STORE TAGS THAN AVAILABLE PHYSICAL REGISTERS IN A MICROPROCESSOR SYSTEM,” filed on Mar. 21, 2002.

### BACKGROUND OF THE INVENTION

1. Field of the Invention

The present invention generally relates to computer systems, and more particularly to a method and system for improving the performance of a processing unit by allowing the unit to assign more logical tags for load/store instructions than there are physical registers for such instructions, in a selectively limited manner.

2. Description of the Related Art

The basic structure of a conventional computer system includes one or more processing units which are connected to various peripheral devices, including input/output (I/O) devices (such as a display monitor, keyboard, and permanent storage device), a memory device (such as random access memory or RAM) that is used by the processing units to carry out program instructions, and firmware whose primary purpose is to seek out and load an operating system from one of the peripherals (usually the permanent memory device) whenever the computer is first turned on. Processing units communicate with the peripheral devices by various means, including a generalized interconnect or system bus. Conventional computer systems may have many additional components such as serial, parallel, USB (universal serial bus), and ethernet ports for connection to, e.g., modems, printers or networks.

The present invention is directed to a mechanism for improving the performance of a processing unit in a computer system. The operation of a typical processing unit may be understood with reference to the example of FIG. 1. In that figure, there is depicted a block diagram of a conventional processor. In the depicted construction, processor 10 comprises a single integrated circuit superscalar microprocessor. As discussed further below, processor 10 includes various execution units, registers, buffers, memories, and other functional units, which are all formed by integrated circuitry. Processor 10 may operate according to reduced instruction set computing (RISC) techniques. Processor 10 is coupled to a system bus 11 via a bus interface unit (BIU) 12 within processor 10. BIU 12 controls the transfer of information between processor 10 and other devices coupled to system bus 11, such as a main memory (not illustrated), by participating in bus arbitration. Processor 10, system bus 11, and the other devices coupled to system bus 11 together form a host data processing system.

BIU 12 is connected to an instruction cache and memory management unit (MMU) 14, and to a data cache and MMU 16 within processor 10. High-speed caches, such as those within instruction cache and MMU 14 and data cache and MMU 16, enable processor 10 to achieve relatively fast access time to a subset of data or instructions previously transferred from main memory to the caches, thus improving the speed of operation of the host data processing system. Instruction cache and MMU 14 is further coupled to a sequential fetcher 17, which fetches instructions for execution from instruction cache and MMU 14 during each cycle. Sequential fetcher 17 transmits branch instructions fetched from instruction cache and MMU 14 to a branch processing unit (BPU) 18 for execution, but temporarily stores sequential instructions within an instruction queue 19 for execution by other execution circuitry within processor 10.

In addition to BPU 18, the execution circuitry of processor 10 has multiple execution units for executing sequential instructions, including a fixed-point unit (FXU) 22, a load-store unit (LSU) 28, and a floating-point unit (FPU) 30. Each of the execution units 22, 28, and 30 typically executes one or more instructions of a particular type of sequential instructions during each processor cycle. For example, FXU 22 performs fixed-point mathematical and logical operations such as addition, subtraction, ANDing, ORing, and XORing, utilizing source operands received from specified general purpose registers (GPRs) 32 or GPR rename buffers 33. Following the execution of a fixed-point instruction, FXU 22 outputs the data results of the instruction to GPR rename buffers 33, which provide temporary storage for the operand data until the instruction is completed by transferring the result data from GPR rename buffers 33 to one or more of GPRs 32. Conversely, FPU 30 typically performs single and double-precision floating-point arithmetic and logical operations, such as floating-point multiplication and division, on source operands received from floating-point registers (FPRs) 36 or FPR rename buffers 37. FPU 30 outputs data resulting from the execution of floating-point instructions to selected FPR rename buffers 37, which temporarily store the result data until the instructions are completed by transferring the result data from FPR rename buffers 37 to selected FPRs 36. As its name implies, LSU 28 typically executes floating-point and fixed-point instructions which either load data from memory (i.e., either the data cache within data cache and MMU 16 or main memory) into selected GPRs 32 or FPRs 36, or which store data from a selected one of GPRs 32, GPR rename buffers 33, FPRs 36, or FPR rename buffers 37 to memory.

Processor 10 may employ both pipelining and out-of-order execution of instructions to further improve the performance of its superscalar architecture. Accordingly, instructions can be executed by FXU 22, LSU 28, and FPU 30 in any order as long as data dependencies are observed. In addition, instructions are processed by each of FXU 22, LSU 28, and FPU 30 at a sequence of pipeline stages. As is typical of high performance processors, each instruction is processed at five distinct pipeline stages, namely, fetch, decode/dispatch, execute, finish, and completion.

During the fetch stage, sequential fetcher 17 retrieves one or more instructions associated with one or more memory addresses from instruction cache and MMU 14. Sequential instructions fetched from instruction cache and MMU 14 are stored by sequential fetcher 17 within instruction queue 19. In contrast, sequential fetcher 17 removes (folds out) branch instructions from the instruction stream and forwards them to BPU 18 for execution. BPU 18 includes a branch prediction mechanism, which may comprise a dynamic prediction mechanism such as a branch history table, that enables BPU 18 to speculatively execute unresolved conditional branch instructions by predicting whether or not the branch will be taken.

During the decode/dispatch stage, dispatch unit 20 decodes and dispatches one or more instructions from instruction queue 19 to execution units 22, 28, and 30, typically in program order. In addition, dispatch unit 20 allocates a rename buffer within GPR rename buffers 33 or FPR rename buffers 37 for each dispatched instruction's result data. Upon dispatch, instructions are also stored within the multiple-slot completion buffer of completion unit 40 to await completion. Processor 10 tracks the program order of the dispatched instructions during out-of-order execution utilizing unique instruction identifiers.

During the execute stage, execution units 22, 28, and 30 execute instructions received from dispatch unit 20 opportunistically as operands and execution resources for the indicated operations become available. Each of execution units 22, 28, and 30 are preferably equipped with a reservation station that stores instructions dispatched to that execution unit until operands or execution resources become available. After execution of an instruction has terminated, execution units 22, 28, and 30 store data results, if any, within either GPR rename buffers 33 or FPR rename buffers 37, depending upon the instruction type. Then, execution units 22, 28, and 30 notify completion unit 40 which instructions have finished execution. Finally, instructions are completed in program order out of the completion buffer of completion unit 40. Instructions executed by FXU 22 and FPU 30 are completed by transferring data results of the instructions from GPR rename buffers 33 and FPR rename buffers 37 to GPRs 32 and FPRs 36, respectively. Load and store instructions executed by LSU 28 are completed by transferring the finished instructions to a completed store queue or a completed load queue from which the load and store operations indicated by the instructions will be performed.

One problem that arises in such conventional processors is the limitation on the number of instructions that can be handled by the load-store unit. An address or “tag” is assigned to a load or store instruction at dispatch time to assist LSU 28 in re-ordering the load and store instructions. The load/store tags are then issued from an issue queue to the LSU along with the load or store instruction for execution. If the instruction is a load, the load tag is latched into the load-reorder queue (LRQ), and if the instruction is a store, the store tag is latched into the store-reorder queue (SRQ). LSU 28 then uses the load/store tags to maintain ordering between the load requests and the store requests in the LRQ and SRQ. Only one load tag can be assigned to a physical location in the LRQ at any one time, and only one store tag can be assigned to a physical location in the SRQ at any one time. The assigned load/store tags remain with the instructions until they are completed. At completion time, the load/store tags are deallocated, and then the same tags can be assigned to another instruction. However, if either the LRQ or the SRQ is full when dispatching new instructions, then the dispatch must be halted, severely degrading processor performance.

In light of the foregoing, it would be desirable to devise a method of allowing the LSU to assign more load/store tags than the number of physical locations available in the LRQ and SRQ in order to reduce the likelihood of such performance degradation. However, there might be circumstances where it would be preferable to limit the provision of such additional tags for load/store locations. For example, the provision of additional tags might lead to greater power requirements, and a power-related issue might make it desirable to disable the usage of such additional tags (at least temporarily). It might also be favorable to limit the use of additional tags, particularly store tags, for field failures or laboratory debug purposes. Accordingly, it would be further advantageous if a mechanism could be provided to selectively limit or adjust the usage of any such additional load/store tags.

### SUMMARY OF THE INVENTION

It is therefore one object of the present invention to provide an improved processor for a computer system.

It is another object of the present invention to provide an improved instruction handling mechanism for a processor which is less likely to cause dispatch halts.

It is yet another object of the present invention to provide a mechanism for assigning more logical load/store tags than available physical registers in a microprocessor system, in a selectively limited manner.

The foregoing objects are achieved in a method of handling instructions in a load/store unit of a processor, generally comprising the steps of dispatching a plurality of instructions to the load/store unit, filling a portion of physical entries of a reorder queue of the load/store unit with a plurality of tags corresponding to the plurality of instructions, while limiting usage of the physical entries of the reorder queue to less than a total number of physical entries, and further dispatching one or more additional instructions to the load/store unit while the filled physical entries in the reorder queue are still full, i.e., still contain tags for uncompleted instructions. The limiting of usage of the physical entries may be selectively applied. Multiple logical instruction tags are assigned in a count greater than the number of physical entries in the reorder queue. Of the multiple logical instruction tags assigned to a single one of the physical entries in the reorder queue, only the tag for the oldest instruction is allowed to execute. A plurality of virtual/multiplier bits (V_{T}) are provided to tag allocations for the load/store unit, and the limiting of usage of the physical entries may be achieved by setting one or more of the virtual bits to prevent usage of a corresponding physical entry. A given V_{T} bit is flipped when a corresponding tag allocation wraps. The most significant bit of a given logical instruction tag is compared with the V_{T} bit to determine whether the given logical instruction tag is valid, i.e., is actually stored in a physical entry of the reorder queue.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a conventional computer processor, illustrating the dispatch of instructions using a load-store unit (LSU);

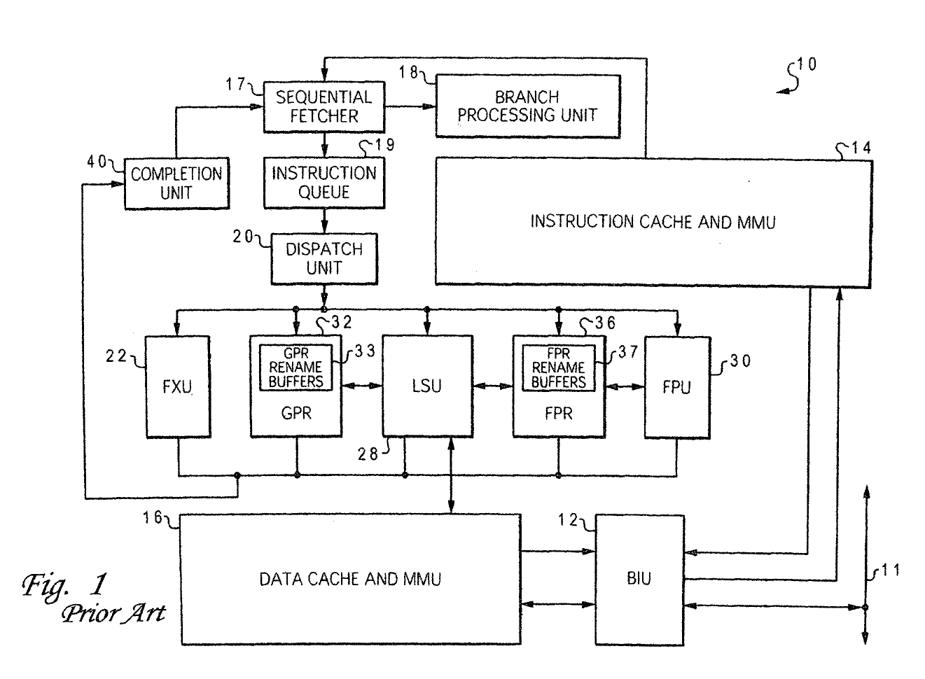

FIG. 2 is a block diagram of processor hardware which handles the dataflow of a virtual load tag (LTAG) in accordance with one implementation of the present invention;

FIG. 3 is a block diagram of processor hardware which handles the dataflow of a virtual store tag (STAG) in accordance with one implementation of the present invention;

FIG. 4 is a chart illustrating the logical flow for the virtual LTAG handling shown in FIG. 2;

FIG. 5 is a chart illustrating the logical flow for the virtual STAG handling shown in FIG. 3; and

FIG. 6 is a sequence of diagrams showing the settings for the store tag virtual bits (STAG V_{T}_{_{—}}_{bit}) according to a further implementation of the invention which selectively limits usage of virtual store tags.

The use of the same reference symbols in different drawings indicates similar or identical items.

### DESCRIPTION OF THE PREFERRED EMBODIMENT(S)

The present invention is directed to a mechanism for improving the performance of a processor by enhancing the operation of the load/store logic within the processor. Although the invention is described in the context of a computer system, those skilled in the art will appreciate that the invention is not so limited, but rather is useful for any processor application.

As noted in the Background section, processor performance suffers when dispatch is halted due to a full load-reorder queue (LRQ) or a full store-reorder queue (SRQ). Considerable performance can be gained by allowing dispatch to continue even though the physical entries in the LRQ or SRQ are full. This performance gain can be achieved with a mechanism whereby multiple logical tags are assigned to the same physical location. Thus, the frequency of dispatch hold due to SRQ and/or LRQ conditions is reduced significantly by making the SRQ/LRQ appear to be larger that their actual physical capacity.

For a physical location in the LRQ, multiple load tags can be assigned making more load tags available than physical locations in the LRQ, leading to the dispatch of more load instructions to the issue queue. Of the multiple load tags assigned to a single physical location in the LRQ, only the oldest load in the group is allowed to execute. Load instructions with younger load tags in the group must remain in the issue queue until that LRQ location has been deallocated (i.e., when the load instruction is completed).

For a physical location in the SRQ, multiple store tags can be assigned making more store tags available than physical locations in the SRQ, leading to the dispatch of more store instructions to the issue queue. Of the multiple store tags assigned to a single physical location in the SRQ, only the oldest load in the group is allowed to execute. Store instructions with younger store tags in the group must remain in the issue queue until that SRQ location has been deallocated (i.e., when the store instruction is completed).

In an illustrative embodiment, the number of physical entries in the LRQ is 32, and the number of physical entries in the SRQ is 32. A virtual bit (V_{T}) is added to both the store tag (STAG) and load tag (LTAG) allocations This virtual, or multiplier, bit becomes the most significant bit of the STAG/LTAG. More than one virtual bit may be so added. If only one bit is used, then the number of SRQ/LRQ entries seen by the dispatch stage is doubled. Adding two bits would quadruple the number of effective SRQ/LRQ entries. In this example, one bit is added to the LTAG, i.e., LTAG(0) is the V_{T} bit, while LTAG(1:5) are pointing to the 32 physical entries in the LRQ. Similarly, one bit is added to the STAG, i.e., STAG(0) is the V_{T} bit, while STAG(1:5) are pointing to the 32 physical entries in the SRQ.

The STAG and LTAG bits are allocated sequentially at dispatch. The V_{T} bit is flipped when the tag allocation wraps. A 32-bit V_{T}_{_{—}}_{bit} vector is maintained by the completion logic and the issue queue for each SRQ/LRQ, i.e., there is one 32-bit LTAG V_{T}_{_{—}}_{bit} vector, and one 32-bit STAG V_{T}_{_{—}}_{bit} vector. These bits individually represent the most significant bit of each of the real LTAG/STAG entries. Thus, if the LTAG V_{T}_{_{—}}_{bit}(0) is zero, then the LTAG entry of “000000” is the real LTAG and is allowed to execute, while the virtual LTAG of “100000” is not allowed to execute and must remain in the issue queue until LTAG “000000” is deallocated. Later, when LTAG “000000” is deallocated, the corresponding V_{T}_{_{—}}_{bit} entry, LTAG V_{T}_{_{—}}_{bit}(0), is flipped, becoming a one. In this manner, the LTAG of “100000” now becomes the real tag and this load instruction will be allowed to execute. At this same time, when a new LTAG of “000000” is allocated to a new instruction from dispatch, it becomes the virtual tag and must thereafter remain in the issue queue until the LTAG of “100000” is deallocated. This same procedure applies to store instructions and the STAG entries.

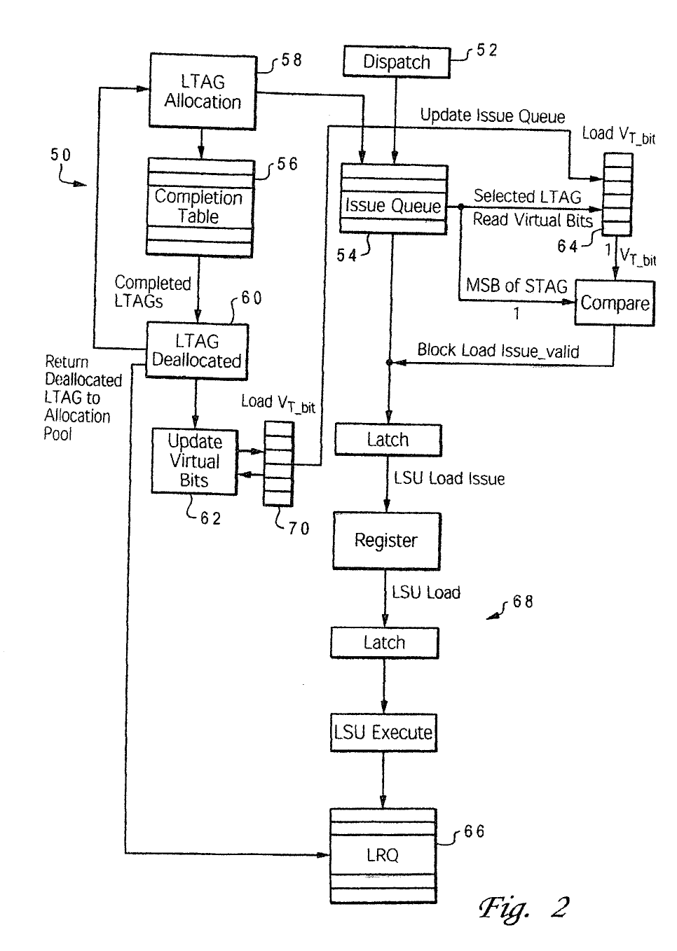

With reference now to the figures, and in particular with reference to FIG. 2, there is depicted a virtual LTAG dataflow in accordance with one implementation of the present invention. A completion unit 50 allocates the LTAG at dispatch time, when the instruction is sent from dispatch unit 52, and the LTAG is latched in the issue queue 54. Completion unit 50 includes a completion table 56, LTAG allocation logic 58, LTAG deallocation logic 60, and update logic 62. Completion table (queue) 56 may be, e.g., 100 instructions deep. Issue queue 54 may be, e.g., 38 instructions deep.

At instruction select time, issue queue 54 uses LTAG(1:5) to read out the appropriate V_{T} bit from the LTAG V_{T}_{_{—}}_{bit} vector 64. Issue queue 54 then uses the most significant bit of the LTAG (bit(0)=V_{T}) to compare with the read-out V_{T} bit performed in the previous step. If these two bits are the same, then the current LTAG is the real LTAG (i.e., loaded into the physical entry in the LRQ 66), and issue queue 54 will turn on an appropriate signal issue_valid. If the bits are not the same (i.e., the LTAG is in the virtual window), then issue queue 54 will block issue_valid from becoming active. When issue queue 54 is issuing a load instruction to the load-store unit (LSU) 68, it will also send the 5-bit LTAG with the instruction (LTAG(1:5)). Instructions are executed sequentially from LRQ 66. During completion, completion unit 50 will deallocate completing LTAG entries to make room for new load instructions to dispatch. The completion unit (update logic 62) will also flip the V_{T}_{_{—}}_{bit} in its own LTAG V_{T}_{_{—}}_{bit} vector 70. The completion logic then sends the updated vector of 32 bits to the issue queue to be latched up at 64. Issue queue 54 then reads the multiplier bits out during instruction selects as just described.

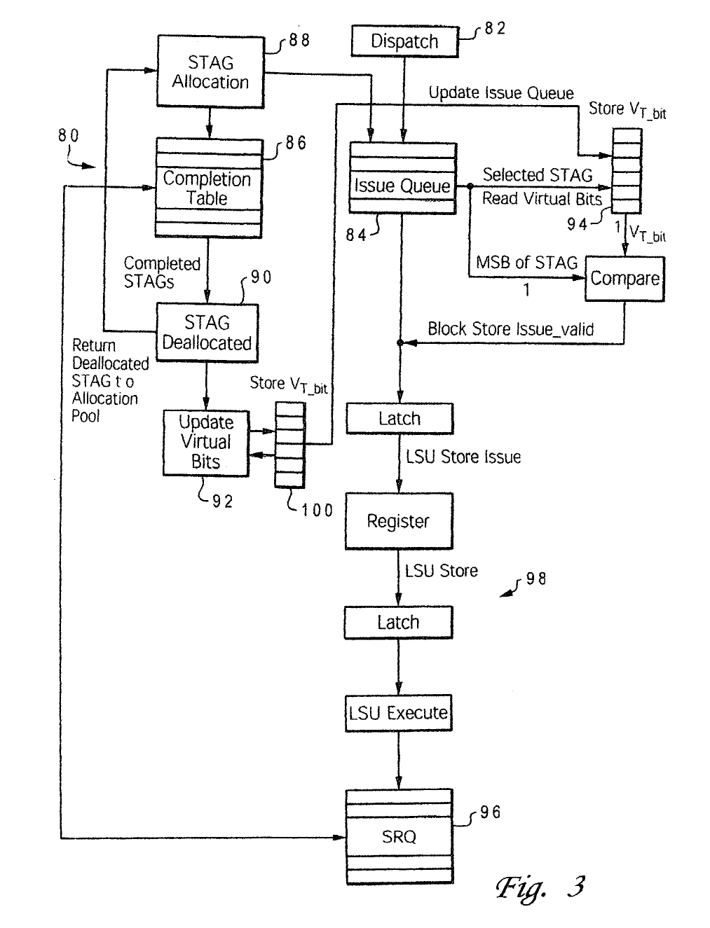

Referring now to FIG. 3, similar circuits are shown for a virtual STAG dataflow in accordance with one implementation of the present invention. A completion unit 80 allocates the STAG at dispatch time, when the instruction is sent from dispatch unit 82, and the STAG is latched in the issue queue 84. Completion unit 80 includes a completion table 86, STAG allocation logic 88, STAG deallocation logic 90, and update logic 92. Completion table (queue) 86 may be, e.g., 100 instructions deep. Issue queue 84 may be, e.g., 38 instructions deep.

At instruction select time, issue queue 84 uses STAG(1:5) to read out the appropriate V_{T} bit from the STAG V_{T}_{_{—}}_{bit} vector 94. Issue queue 84 then uses the most significant bit of the STAG (bit(0)=V_{T}) to compare with the read-out V_{T} bit performed in the previous step. If these two bits are the same, then the current STAG is the real STAG (i.e., loaded into the physical entry in the SRQ 96), and issue queue 84 will turn on an appropriate signal issue_valid. If the bits are not the same (i.e., the STAG is in the virtual window), then issue queue 84 will block issue valid from becoming active. When issue queue 84 is issuing a load instruction to the load-store unit (LSU) 98, it will also send the 5-bit STAG with the instruction (STAG(1:5)). Instructions are executed sequentially from SRQ 96. During completion, completion unit 80 will deallocate completing STAG entries to make room for new load instructions to dispatch. The completion unit (update logic 92) will also flip the V_{T}_{_{—}}_{bit} in its own STAG V_{T}_{_{—}}_{bit} vector 100. The completion logic then sends the updated vector of 32 bits to the issue queue to be latched up at 94. Issue queue 84 then reads the multiplier bits out during instruction selects as just described.

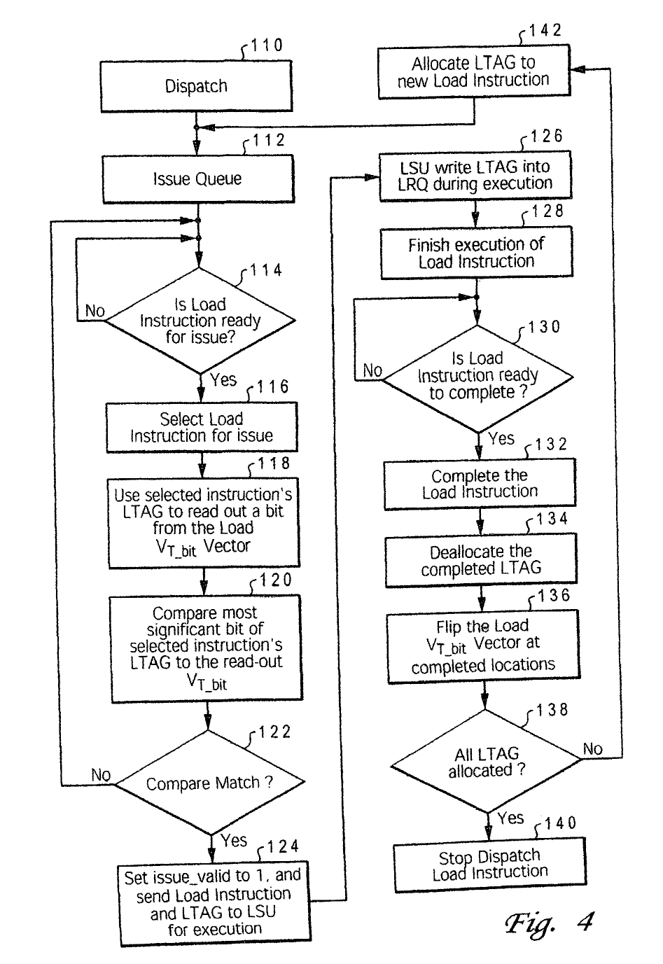

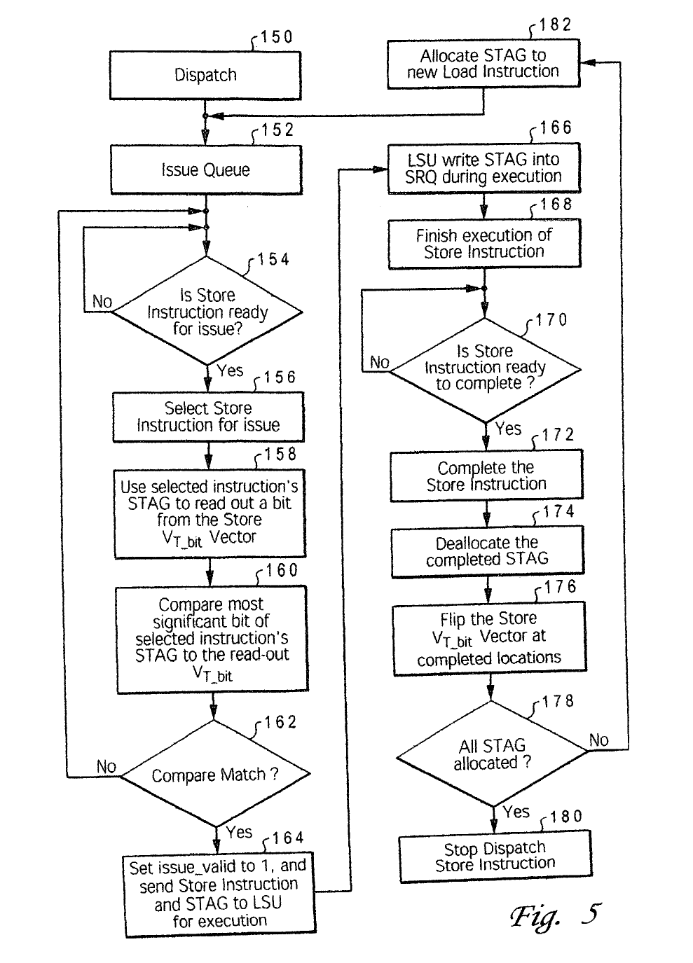

The invention may be further understood with reference to the flow charts of FIGS. 4 and 5. FIG. 4 illustrates the logical flow for the virtual LTAG handling using the mechanism illustrated in FIG. 2. After dispatch (110), the instruction and its tag are loaded into the issue queue (112). A determination is then made as to whether the load instruction is ready for issue (114). If not, the process cycles until the load instruction is ready, and then the load instruction is selected for issue (116). The selected instruction's LTAG is used to read out the virtual bit from the LTAG V_{T}_{_{—}}_{bit} vector (118). The most significant bit of the selected instruction's LTAG is compared to the read-out V_{T}_{_{—}}_{bit} (120), and if it matches (122) then the issue_valid signal is set, and the load instruction and LTAG are sent to the LSU for execution (124). If the compare operation does not yield a match, the process returns to step 114. The LSU proceeds to write the LTAG into the LRQ during execution (126), and the execution is finished (128). A determination is then made as to whether the load instruction is ready to complete (130). If not, the process cycles until the load instruction is ready for completion, and is then completed (132). The completed LTAG is deallocated (134), and the corresponding bit in the LTAG V_{T}_{_{—}}_{bit} vector is flipped (136). If all LTAGs have been allocated, dispatching must stop (140); otherwise, a new LTAG is allocated to a new load instruction (142), and the process iterates at step 112.

FIG. 5 illustrates the logical flow for the virtual STAG handling using the mechanism illustrated in FIG. 2. After dispatch (150), the instruction and its tag are loaded into the issue queue (152). A determination is then made as to whether the store instruction is ready for issue (154). If not, the process cycles until the store instruction is ready, and then the store instruction is selected for issue (156). The selected instruction's STAG is used to read out the virtual bit from the STAG V_{T}_{_{—}}_{bit} vector (158). The most significant bit of the selected instruction's STAG is compared to the read-out V_{T}_{_{—}}_{bit} (160), and if it matches (162) then the issue_valid signal is set, and the store instruction and STAG are sent to the LSU for execution (164). If the compare operation does not yield a match, the process returns to step 154. The LSU proceeds to write the STAG into the SRQ during execution (166), and the execution is finished (168). A determination is then made as to whether the store instruction is ready to complete (170). If not, the process cycles until the store instruction is ready for completion, and is then completed (172). The completed STAG is deallocated (174), and the corresponding bit in the STAG V_{T}_{_{—}}_{bit} vector is flipped (176). If all STAGs have been allocated, dispatching must stop (180); otherwise, a new STAG is allocated to a new store instruction (142), and the process iterates at step 152.

While the foregoing technique is highly desirable for extending processor performance by avoiding halts of instruction dispatch, there may be different circumstances under which it is preferable to limit the provision of virtual tags for load/store locations. For example, the provision of additional tags might lead to greater power requirements, and a power-related issue might make it desirable to disable the usage of virtual tags, or a portion of the virtual tags (at least temporarily), to effectuate a partial machine shut down. It might also be favorable to limit the use of virtual tags, particularly store tags, for field failures or laboratory debug purposes. The onboard (L1) data cache, or a second level (L2) cache, might have a problem relating to an excessive number of pending store operations in the cache pipeline. Limiting the number of available store tags at the processor would reduce the number of pending stores in the cache queue. The foregoing embodiment does not, however, allow any flexibility in implementing the virtual tags, i.e., either the virtual tag allocation is used for all entries, or for none at all.

Accordingly, in a further embodiment, a mechanism is provided to selectively limit or adjust the usage of virtual load/store tags, while largely retaining the virtual tag allocation algorithm. With this embodiment, the virtual buffer and the SRQ physical sizes can be adjusted as needed, according to the particular circumstances. Also, modeling experiments show that if the virtual buffer and SRQ physical sizes are reduced by only a few entries, there is very little performance loss.

In this further embodiment (wherein the number of physical entries in the SRQ may again be 32), the STAG V_{T}_{_{—}}_{bit} vector entries are initialized differently from the manner of initialization for the earlier described embodiment. According to the method first described above, all of the bits in the STAG V_{T}_{_{—}}_{bit} vector are initialized to zero, to indicate that entries “0” through “31 ” are in the real window (i.e., instructions with STAGs from “0” to “31” are issueable to execution, while instructions with STAGs from “32” to “63” are dispatchable but not issueable to execution). However, according to the more flexible method, all of the bits in the STAG V_{T}_{_{—}}_{bit} vector except the final bit (bit 31, the least significant bit) are initialized to zero, but the least significant bit (corresponding to the 32^{nd} store tag) is initialized to one. Additionally, the STAG of “111111” (the 32^{nd} store tag) is not allowed to dispatch at this time. In this manner, STAGs from “0” to “30” are allocated to SRQ physical entries 0 to 30, but entry 31 is not allowed to used, resulting in a usage reduction of one SRQ entry (i.e., STAG “011111” is not allowed to issue). Also, this initialization allows the dispatch of STAGs from “000000” to “111110” but, as noted, STAG “111111” is not allowed to dispatch; if STAG “011111” and “111111” were both allowed to dispatch, and STAG “011111” belongs to an older instruction, then the STAG V_{T}_{_{—}}_{bit} at entry 31 set to one will allow the instruction with STAG “111111” to issue ahead of the instruction with STAG “011111”.

The completion unit will allocate STAGs sequentially, as before, to new instructions at dispatch time. During completion time, the completion unit will deallocate completing STAG entries to make room for new store instructions to dispatch. When the completion unit is completing STAG “000000”, the completion logic will flip the V_{T}_{_{—}}_{bit} at location “31 ” to a zero in order to allow the instruction with STAG “011111” to subsequently issue. STAG “111111” is then allowed to dispatch, and STAG “000000” is not allowed to dispatch until STAG “000001” is completed and deallocated. In other words, when a given STAG (n) is completed, the same STAG (n) is not allocated to a new instruction for dispatch until after the next STAG (n+1) is completed.

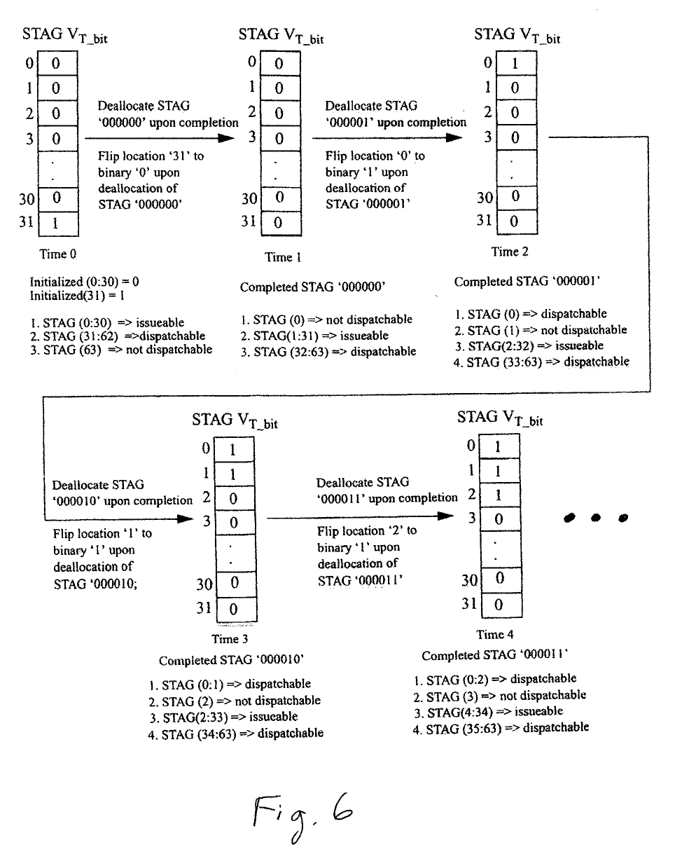

This same process applies to all STAGs, as illustrated in FIG. 6. First, at time 0, the STAG V_{T}_{_{—}}_{bit} is initialized as described above, with STAG (0:30) being issueable, STAG (31:62) being dispatchable, and STAG (63) not being dispatchable. When STAG “000000” is completed, it is deallocated, and location “31 ” in the vector is flipped to zero. At time 1 (completion of STAG “000000”), STAG (0) is not dispatchable, while STAG (1:31) are issueable, and STAG (32:63) are dispatchable. When STAG “000001” is completed, it is deallocated, and location “0” in the vector is flipped to one. At time 2 (completion of STAG “000001”), STAG (0) becomes dispatchable, while STAG (1) is not dispatchable, STAG (2:32) are issueable, and STAG (33:63) are dispatchable. When STAG “000010” is completed, it is deallocated, and location “1” in the vector is flipped to one. At time 3 (completion of STAG “000010”), STAG (0:1) are dispatchable, while STAG (2) is not dispatchable, STAG (3:33) are issueable, and STAG (34:63) are dispatchable. When STAG “000011” is completed, it is deallocated, and location “2” in the vector is flipped to one. At time 4 (completion of STAG “000011”), STAG (0:2) are dispatchable, while STAG (3) is not dispatchable, STAG (4:34) are issueable, and STAG (35:63) are dispatchable. The process continues until it returns to the initialization state and then repeats.

While this more flexible approach has been describe with regard to the store tags, those skilled in the art will appreciate that it may be applied to the load tags in the same manner. Also, the initialization of the STAG V_{T}_{_{—}}_{bit} may be further altered to provide varying adjustment of the virtual tag usage. In the foregoing method, the usage of the SRQ is limited to 31 entries out of a total of 32 potential entries, but the same technique may be used to limit usage of the SRQ to fewer than 31 entries. For example, to limit usage of the SRQ to 30 entries out of the potential 32, the STAG V_{T}_{_{—}}_{bit} vector is initialized by setting entries (0:29) to zeros and setting entries (30:31) to ones, while preventing STAGs “111110” and “111111” from being allocated for dispatch. When STAG “000000” is completed and deallocated, STAG V_{T}_{_{—}}_{bit} entry “30” is flipped to zero and STAG “111110” is allowed to dispatch, while STAGs “111111” and “000000” are not allowed to dispatch. The process continues in the same manner for all STAGs. Limiting usage of the physical entries in the SRQ may be selectively applied, in response to a particular application, or a system setting.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A method of handling instructions in a load/store unit of a processor, comprising the steps of:
dispatching a plurality of instructions to the load/store unit;
filling a portion of physical entries of a reorder queue of the load/store unit with a plurality of tags corresponding to the plurality of instructions, respectively, while limiting usage of the physical entries of the reorder queue to less than a total number of physical entries; and
further dispatching one or more additional instructions to the load/store unit, after said filling step, while the filled physical entries in the reorder queue contain tags for uncompleted instructions.

2. The method of claim 1 wherein the reorder queue is a store reorder queue, and said filling step fills the portion of physical entries of the store reorder queue with store instruction tags.

3. The method of claim 1 wherein the limiting of the usage of the physical entries of the reorder queue is selectively applied.

4. The method of claim 1, further comprising the step of assigning multiple logical instruction tags in a count greater than a number of the physical entries in the reorder queue.

5. The method of claim 4 wherein, of the multiple logical instruction tags assigned to a single one of said physical entries in the reorder queue, only a tag for an oldest instruction is allowed to execute.

6. The method of claim 4, further comprising the step of providing a plurality of virtual bits (V_{T}) to tag allocations for the load/store unit, and wherein said limiting of usage of the physical entries of the reorder queue is achieved by setting one or more of the virtual bits to prevent usage of a corresponding physical entry.

7. The method of claim 6, further comprising the step of flipping a given V_{T} bit when a corresponding tag allocation wraps.

8. The method of claim 6, further comprising the step of comparing a most significant bit of a given logical instruction tag with a corresponding V_{T} bit to determine whether the given logical instruction tag is valid.

9. A processor comprising:
a plurality of registers;
at least one memory unit storing program instructions;
a plurality of execution units including at least one load/store unit;
means for dispatching a plurality of instructions to said load/store unit and filling a portion of physical entries of a reorder queue of said load/store unit with a plurality of tags corresponding to the plurality of instructions, respectively, while limiting usage of said physical entries of said reorder queue to less than a total number of physical entries; and
means for allowing one or more additional instructions to be dispatched to said load/store unit while said filled physical entries in said reorder queue contain tags for uncompleted instructions.

10. The processor of claim 9 wherein said reorder queue is a store reorder queue, and said dispatching means fills all physical entries of said store reorder queue with store instruction tags.

11. The processor of claim 9 wherein said limiting of usage of said physical entries of said reorder queue is selectively applied.

12. The processor of claim 9 wherein said allowing means assigns multiple logical instruction tags in a count greater than a number of said physical entries in said reorder queue.

13. The processor of claim 12 wherein, of the multiple logical instruction tags assigned to a single one of said physical entries in said reorder queue, only a tag for an oldest instruction is allowed to execute.

14. The processor of claim 12 wherein said allowing means provides a plurality of virtual bits (V_{T}) to tag allocations for said load/store unit, and the limiting of usage of said physical entries of said reorder queue is achieved by setting one or more of the virtual bits to prevent usage of a corresponding physical entry.

15. The processor of claim 14 wherein said allowing means flips the V_{T} bit when a corresponding tag allocation wraps.

16. The processor of claim 14 wherein said allowing means compares a most significant bit of a given logical instruction tag with the V_{T} bit to determine whether the given logical instruction tag is valid.

17. A computer system comprising:
at least one memory device;
at least one interconnection bus connected to said memory device; and
processor means connected to said interconnection bus for carrying out program instructions, said processor means including at least one load/store unit, wherein a plurality of instructions are dispatched to said load/store unit and fill a portion of physical entries of a reorder queue of said load/store unit with a plurality of tags corresponding to the plurality of instructions, respectively, and one or more additional instructions are allowed to be dispatched to said load/store unit while all of said physical entries in said reorder queue contain tags for uncompleted instructions, said processor means limiting usage of said physical entries of said reorder queue to less than a total number of physical entries.

18. The computer system of claim 17 wherein said reorder queue is a store reorder queue, and said dispatching means fills all physical entries of said store reorder queue with store instruction tags.

19. The computer system of claim 17 wherein limiting of usage of said physical entries of said reorder queue is selectively applied.

20. The computer system of claim 17 wherein said load/store unit assigns multiple logical instruction tags in a count greater than a number of the physical entries in said reorder queue.

21. The computer system of claim 20 wherein, of the multiple logical instruction tags assigned to a single one of said physical entries in said reorder queue, only a tag for an oldest instruction is allowed to execute.

22. The computer system of claim 20 wherein said load/store unit provides a plurality of virtual bits (V_{T}) to tag allocations, and the limiting of usage of said physical entries of said reorder queue is achieved by setting one or more of the virtual bits to prevent usage of a corresponding physical entry.

23. The computer system of claim 22 wherein said load/store unit flips the V_{T} bit when a corresponding tag allocation wraps.

24. The computer system of claim 22 wherein said load/store unit compares a most significant bit of a given logical instruction tag with the V_{T} bit to determine whether the given logical instruction tag is valid.
